(19) United States
(12) Patent Application Publication
(10) Pub. No.: US 2022/0153551 A1
(43) Pub. Date: May 19, 2022

(54) METHOD AND APPARATUS FOR CONTROLLING ELEVATOR

(71) Applicants: ELECTRONICS AND TELECOMMUNICATIONS RESEARCH INSTITUTE, Daejeon (KR); M2M Tech Co.,Ltd., Seongnam-si (KR)

(72) Inventors: Yun Chul CHOI, Daejeon (KR); JinKee KIM, Seongnam-si (KR); Jung Soo PARK, Daejeon (KR)

(73) Assignees: ELECTRONICS AND TELECOMMUNICATIONS RESEARCH INSTITUTE, Daejeon (KR); M2M Tech Co.,Ltd., Seongnam-si (KR)

(21) Appl. No.: 17/526,713

(22) Filed: Nov. 15, 2021

(30) Foreign Application Priority Data
Nov. 17, 2020 (KR) 10-2020-0153977
Nov. 17, 2020 (KR) 10-2020-0153978
Oct. 27, 2021 (KR) 10-2021-0144867
Oct. 27, 2021 (KR) 10-2021-0144868

(51) Int. Cl. B66B 1/34; H04L 29/06

(52) U.S. Cl. CPC B66B 1/3453; B66B 1/3461; H04L 63/10; H04L 63/123

(57) ABSTRACT

A method for controlling an elevator by interworking with external devices in an apparatus for controlling an elevator is provided. The method for controlling an elevator includes generating token information for an external device to which a write command is to be performed and transmitting the token information to the external device, receiving a control message including a write command together with the token information from the external device, verifying the token information, and processing the control message when the token information is verified.

### CROSS-REFERENCE TO RELATED APPLICATION

This application claims priority to and the benefit of Korean Patent Application Nos. 10-2020-0153977, 10-2020-0153978, 10-2021-0144867, and 2021-0144868 filed in the Korean Intellectual Property Office on Nov. 17, 2020, Nov. 17, 2020, Oct. 27, 2021, and Oct. 27, 2021, the entire contents of which are incorporated herein by reference.

### BACKGROUND OF THE INVENTION

### (a) Field of the Invention

The present invention relates to a method and apparatus for controlling an elevator, and more particularly, to a method and apparatus for controlling an elevator that can safely control the elevator by interworking with external data based on a device additionally installed in the elevator, or the elevator.

### (b) Description of the Related Art

An elevator is a mechanical device for moving that is often used in real life. Since the elevator is a device used to move people, safety is very important. For this reason, devices such as a vibration sensor, a fire detection sensor, and an earthquake sensor are being developed to ensure elevator safety, and the newly developed devices are being installed in a new elevator or a previously installed elevator.

Recently, an emergency elevator that can be used in case of emergency has been developed. Such the emergency elevator is an elevator manufactured by reinforcing durability so that the existing elevator can be supported in case of emergency. In the case of such the elevators, a method and apparatus for detecting and responding to emergency situations and emergencies are required.

The safety problem of the elevator itself can be diagnosed through the devices installed inside the elevator. However, in the case of an emergency that occurs inside a building, it is difficult to accurately determine only the internal data of the elevator. For this, at least one sensor is installed in the elevator, and a method of detecting and operating in an emergency situation based on the sensor may be used. However, this method increases the cost because at least one sensor needs to be added to the elevator, and the difficulty in management increases since it must be installed individually in the elevator. In addition, even in situations that occur externally, such as earthquakes, there is a limit to realize the emergency situation using internal data or an added sensor. In addition, there may be cases in which additional sensors cannot be installed in the elevator due to problems such as structure and installation.

### SUMMARY OF THE INVENTION

The disclosure has been made in an effort to provide a method and apparatus for controlling an elevator capable of enhancing elevator safety and supporting emergency operation.

Furthermore, the disclosure has been made in an effort to provide a method and apparatus for controlling an elevator capable of resolving security accidents and control collision that occur in an elevator environment for network interworking.

According to an embodiment, a method for controlling an elevator by interworking with external devices in an apparatus for controlling the elevator is provided. The method for controlling the elevator includes: generating token information for an external device to which a write command is to be performed and transmitting the token information to the external device; receiving a control message including a write command together with the token information from the external device; verifying the token information; and processing the control message when the token information is verified.

The method for controlling the elevator may further include receiving a result of the write command from the elevator and transmitting the result to the external device, and deleting the token information.

The transmitting of the token information may include checking the write authority of the external device based on the information of the external device.

The method for controlling the elevator may further include storing and managing information on devices for which write authority is set by an administrator.

The method for controlling the elevator may further include allocating priorities of devices capable of instructing a control command to the elevator.

The devices include a control panel, a monitoring panel, and the external device, and the allocating of priorities includes allocating priorities in the order of the control panel, the monitoring panel, and the external device.

The control message includes a priority field, and each bit in the priority field is allocated for the priority setting of the devices, and the devices set the priority by activating the allocated bit.

The processing of the control message may include processing received messages based on the priorities of the devices and values of bits in the priority field when control messages including the same or conflicting control commands are received from two or more devices.

According to another embodiment, an apparatus for controlling an elevator that controls the elevator by interworking with an external device through a network is provided. The apparatus for controlling the elevator includes: a user information database that stores a write authority device list including information on devices with write authority and user information of devices having access authority of the elevator; and a security setter that manages the access authority of the external device, provides a temporary authority for executing a control command to the device with the write authority, and sets the priorities of the devices having the access authority.

The security setter may provide token information to an external device that wants to perform a write command, and may delete the token information when the write command is completed.

The security setter, before providing the token information, may check the write authority of the external device based on the information of the external device that wants to perform the write command.

The security setter may allocate priorities in the order of a control panel, a monitoring panel, and the external device.

The control command may include a priority field, each bit in the priority field may be allocated for the priority setting of each device, and the each device sets the priority by activating the allocated bit.

The apparatus for controlling the elevator may further include a data processor that processes received control commands based on the priorities of the devices and values of bits in the priority field when receiving the same or conflicting control commands from two or more devices.

The security setter may basically provide read authorities to the devices having the access authority, and registers the information of the device for which the write authority is set by an administrator to the write authority device list.

According to another embodiment, a method for controlling an elevator by interworking with a control panel or a monitoring panel of the elevator in an apparatus for controlling an elevator is provided. The method for controlling an elevator includes: supporting interworking with external devices installed outside the elevator; processing external data from the external device and internal data of the elevator using an elevator resource table; and monitoring the elevator using the external data and the internal data, and when resources of the elevator are divided into a plurality of groups, the elevator resource table includes a group identifier for identifying each group and a resource identifier for identifying individual devices located in each group.

The processing may include: mapping the external device to a virtual sensor; and managing the resource identifier of the virtual sensor as another group among the plurality of groups.

The managing may include allocating the resource identifier of the virtual sensor by utilizing the most significant bit value of the resource identifier of the external device.

The processing may further include: receiving an external data request from inside the elevator; and collecting the external data through interworking with the external device according to the external data request, wherein the external data request may include the resource identifier of the device to be requested.

The processing may further include: receiving a data request from outside the elevator; and when the device corresponding to the data request is not installed in the elevator, collecting data corresponding to the data request through interworking with the external device and transmitting the data to the outside of the elevator, wherein the data request may include a resource identifier of a device to be requested.

### BRIEF DESCRIPTION OF THE DRAWINGS

FIGS. 1 to 3 are diagrams illustrating an example of an apparatus for controlling an elevator according to an embodiment, respectively.

FIG. 4 is a diagram illustrating a function of a gateway for data interworking according to an embodiment.

FIG. 5 is a diagram illustrating an example of a message structure used in a control panel protocol according to an embodiment.

FIG. 6 is a diagram illustrating a process of interworking with an external server in an elevator according to an embodiment.

FIGS. 7 to 9 are diagrams illustrating a process of interworking with an external sensor in an elevator according to an embodiment, respectively.

FIGS. 10 and 11 are diagrams illustrating an example of a control message structure according to an embodiment, respectively.

FIG. 12 is a diagram illustrating a security method of an apparatus for controlling an elevator according to an embodiment.

FIG. 13 is a diagram illustrating an apparatus for controlling an elevator according to an embodiment.

FIG. 14 is a diagram illustrating an apparatus for controlling an elevator according to another embodiment.

FIG. 15 is diagram illustrating an apparatus for controlling an elevator according to another embodiment.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Now, a method and apparatus for controlling an elevator according to an embodiment will be described in detail with reference to the drawings.

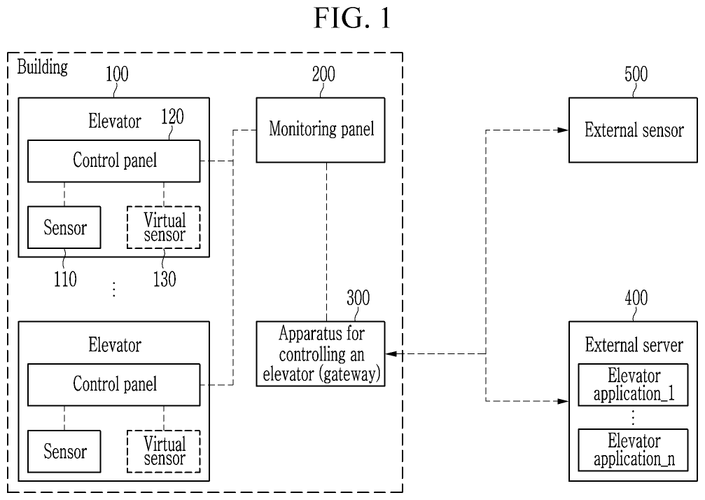

FIGS. 1 to 3 are diagrams illustrating an example of an apparatus for controlling an elevator according to an embodiment, respectively.

Referring to FIG. 1, the elevator 100 is installed inside a building. The elevator 100 includes an internal sensor 110 that collects elevator internal data generated inside the elevator 100 for various safety and control purposes, and a control panel 120 that controls internal sensor 110 and the interior of the elevator 100.

The control panel 120 is connected to the monitoring panel 200 for monitoring a plurality of elevators installed inside the building.

The monitoring group 200 is installed inside the building and managed by a building manager.

The apparatus for controlling an elevator 300 may be connected to the monitoring panel 200 to remotely monitor the elevator 100, and perform functions of a gateway between the inside and the outside of the elevator 100. The apparatus for controlling an elevator 300 may be installed inside or outside the building, and collects and analyzes the elevator internal data generated inside the elevator 100 and the elevator external data collected through an external device installed outside the elevator 100, and controls the elevator 100 based on the analysis results. For this, the apparatus for controlling an elevator 300 analyzes the elevator internal data and the elevator external data by interworking the elevator internal data and the elevator external data.

The apparatus for controlling an elevator 300 generates virtual sensors 130 by one-to-one mapping of external devices, and manages the virtual sensors 130. The apparatus for controlling the elevator 300 virtualizes the external device like a sensor inside the elevator, and processes external elevator data collected from the external device.

The external device may include, for example, the external server 400 and/or the external sensor 500.

The external sensor 500 may include an Internet of Thing (IoT) sensor such as a vibration sensor, a fire detection sensor, and an earthquake sensor.

The external server 400 may be an elevator application server or a data server for storing and managing public data.

A structure for data interworking may be defined as type 1, type 2, and type 3.

Type 1 is a structure in which the apparatus for controlling the elevator 300 interworks elevator internal data collected by the monitoring panel 200 and elevator external data of an external device collected through a gateway, as shown in FIG. 1. At this time, the apparatus for controlling the elevator 300 performs functions of a gateway.

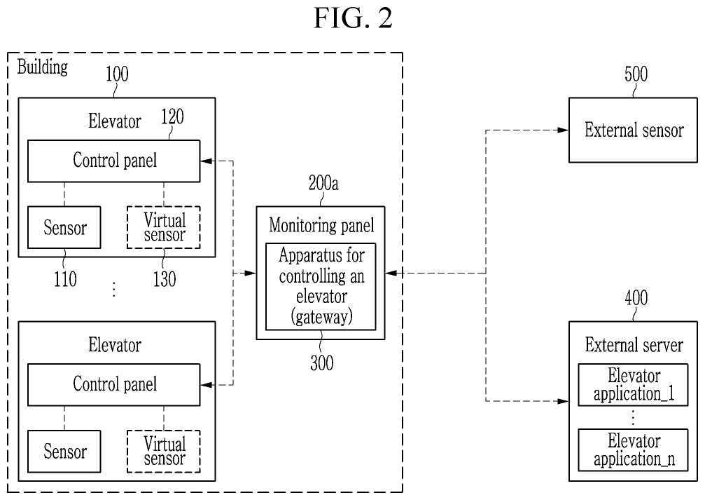

Type 2 is a structure that performs the functions of a gateway in the monitoring panel 200a, as shown in FIG. 2. In this case, the monitoring panel 200a may implement the functions of the apparatus for controlling the elevator 300 shown in FIG. 1.

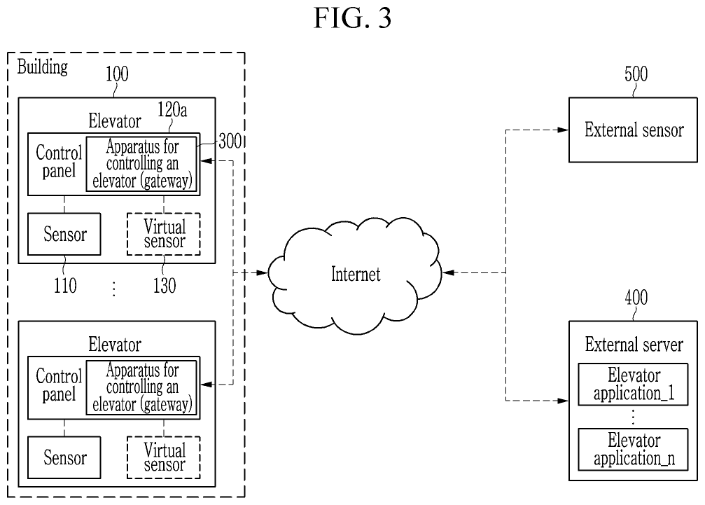

Type 3 is a structure in which the control panel 120a performs the functions of a gateway, and as shown in FIG. 3, the control panel 120a directly interworks with an external device through the Internet. In this case, the control panel 120a may implement the functions of the elevator control device 300 shown in FIG. 1.

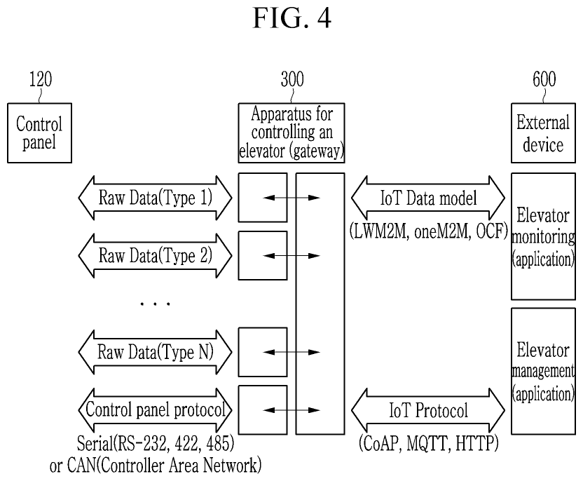

FIG. 4 is a diagram illustrating functions of a gateway for data interworking according to an embodiment.

Referring to FIG. 4, the apparatus for controlling the elevator 300 performing the functions of the gateway may be implemented in the monitoring panel 200a by expanding the monitoring panel 200a, or may be implemented in the control panel 120a by expanding the control panel 120a.

The apparatus for controlling the elevator 300 collects elevator external data through interworking with the external device 600, collects elevator internal data through interworking with the control panel 120 of the elevator 100, and transmits the collected data to an external device 600.

The apparatus for controlling the elevator 300 supports a physical layer supporting serial communication used in the elevator 100 in order to interwork with the control panel 120. Serial communication used in the elevator 100 may include, for example, a recommended standard RS-232, RS-422, RS-485, and the like. When a physical layer such as RS-232, RS-422, or RS-485 is supported, the apparatus for controlling the elevator 300 uses a communication protocol and data model corresponding to the physical layer. Some elevators also support a Controller Area Network (CAN). Accordingly, the apparatus for controlling the elevator 300 may use a protocol and data model supporting a CAN.

The protocol and data model used between the apparatus for controlling an elevator 300 and the external device 600 may be a protocol and data model used in the IoT environment. The apparatus for controlling the elevator 300 may communicate with the external device 600 having a network interface for external connection. For this, IoT data model and IoT protocol can be used. For example, the apparatus for controlling an elevator 300 may use a data model such as Lightweight Machine to Machine (LWM2M), oneM2M, or Open Connectivity Foundation (OCF). The apparatus for controlling an elevator 300 may use a communication protocol such as a Constrained Application Protocol (CoAP), a Message Queue for Telemetry Transport (MQTT), or a HyperText Transfer Protocol (HTTP).

The apparatus for controlling the elevator 300 manages an elevator resource table for interworking with elevator external data of the external device 600. The apparatus for controlling the elevator 300 may define a group identifier (ID) and a resource ID for the elevator resource table, and may map the group ID and the resource ID with information such as that of the external device 600 and a request Uniform Resource Locator (URL).

The group ID identifies the group when classifying the elevator resource into a group. For example, an elevator may be classified into elevator resource groups such as a hoistway, a car, a platform, and a pit, and a group ID is allocated to each elevator resource group. Each elevator resource group has sub-device resources such as lower-level sensors and lower-level devices, and the lower-level device resources may be identified by resource IDs. In the elevator system, an object identifier (OID) may be used as a group ID, and a relative identifier (RID) may be used as a resource ID.

In addition, the apparatus for controlling the elevator 300 may distinguish and define the real sensor and the virtual sensor not only in the extension group but also in the RID of each elevator resource group OID.

The apparatus for controlling the elevator 300 may reserve a virtual resource identifier value to use the virtual resource and allocate it to the virtual resource later. For example, a value obtained by changing the most significant bit to another value in the RID of each ODI may be reserved for a virtual resource. In this case, an actual external sensor and a virtual sensor may be distinguished by utilizing the most significant bit of the RID.

Also, the apparatus for controlling the elevator 300 may define the extension group to define a virtual device for connecting an additional device to the elevator. The extension group may be defined as a group other than the elevator resource group such as the hoistway, the car, the platform, the pit, and the like, and an OID for the extension group may be allocated. In the RID under the extension group defined in the OID, the real sensor and the virtual sensor may be separately defined. The OID and RID consist of 1 byte, respectively, and a real external sensor and a virtual sensor can be distinguished by utilizing the most significant bit of the RID. For example, the OID of the hoistway is 0000 0001, the OID of the car is 0000 0010, the OID of the platform is 0000 0100, the OID of the pit is 0000 1000, and the OID of the extension group is 0001 0000. In this case, the RID of the virtual sensor in the RID under the extension group 0001 0000 may be defined as 1xxx xxxx, and the RID of the real external sensor may be defined as 0xxx xxxx.

In this way, if an extension group is defined to connect an additional external device to the elevator, the external device can be easily managed by mapping the external device to a virtual device based on the extension group, and an additional external device is also connected to the legacy elevator system, and can be easily managed.

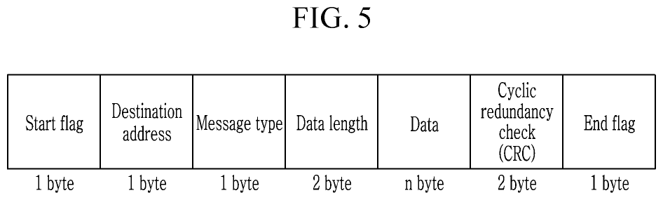

FIG. 5 is a diagram illustrating an example of a message structure used in a control panel protocol according to an embodiment.

Referring to FIG. 5, the messages used in the control panel protocol between the control panel 120 and the elevator control device 300 include fields such as a start flag, an end flag, a destination address, a message type, a data length, a data and a cyclic redundancy check (CRC) for checking errors. The start flag field, the end flag field, the destination address field, and the message type field may have a size of 1 byte, respectively. The data length field and the CRC field may have a size of 2 bytes.

The start flag field and the end flag field indicate the start and end of a message, respectively.

The destination address field may include a broadcast address, an individual address, and a reserved address of a virtual sensor.

The data length field indicates the length of data.

The message type field indicates messages such as data request, data response, data update request, and data update response.

The data field contains data. Depending on the type of message, it is possible to define the data field part in the message structure.

The data field of the data request message may include an object identifier (OID), a relative identifier (RID), and masks (OIDMASK, RIDMASK). The OID indicates a group ID when classifying an elevator resource into an elevator resource group. The RID represents a resource ID. That is, the RID is used to define the device resource under each group. Also, it is possible to request a plurality of pieces of resource information using the masks.

The data field of the data response message may include OID, RID, length, and value. The data field of the data update request message may be configured the same as the data field of the data request message.

The data field of the data update response message may include OID, RID, and results. The results can indicate success, failure, no, change rejection, and so on.

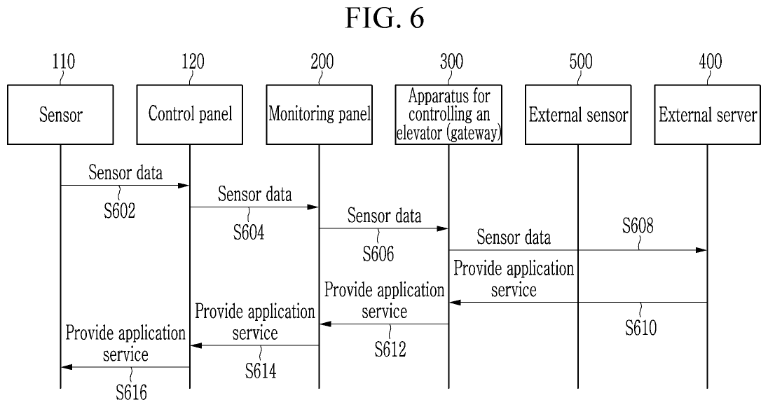

FIG. 6 is a diagram illustrating a process of interworking with an external server in an elevator according to an embodiment.

Referring to FIG. 6, the control panel 120 of the elevator 100 receives the sensor data of the sensor 110 (S602), and transmits the received sensor data to the monitoring panel 200 (S604).

The monitoring panel 200 transmits sensor data to the apparatus for controlling an elevator 300 performing a gateway function (S606), and the apparatus for controlling the elevator 300 processes sensor data according to a protocol and data model for interworking with the external server 400, and transmits the processed sensor data to the external server 400 (S608).

The external server 400 processes the sensor data and transmits a message for providing an application service to the apparatus for controlling the elevator 300 (S610).

The apparatus for controlling the elevator 300 processes the message received from the external server 400 according to the protocol and data model for interworking with the control panel 120, and transmits the processed message for providing the application service to the control panel 120 through the monitoring panel 200 (S612, S614).

The control panel 120 may transmit the received message for providing the application service to the sensor 110 (S616).

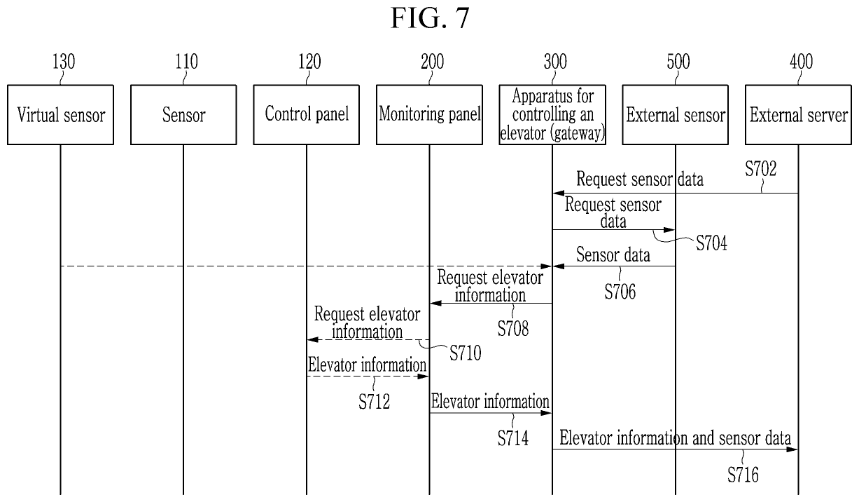

FIGS. 7 to 9 are diagrams illustrating a process of interworking with an external sensor in an elevator according to an embodiment, respectively.

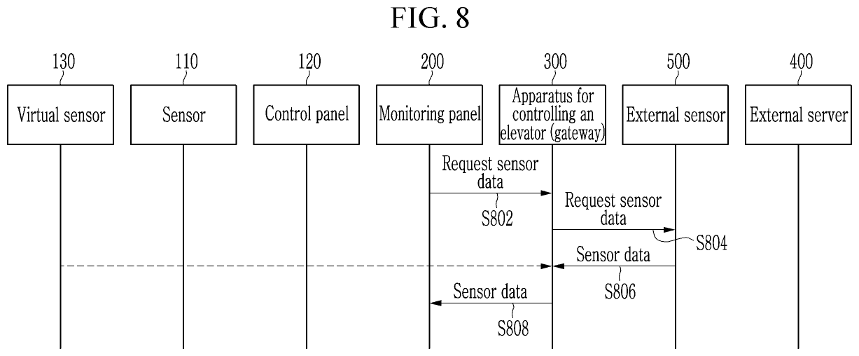

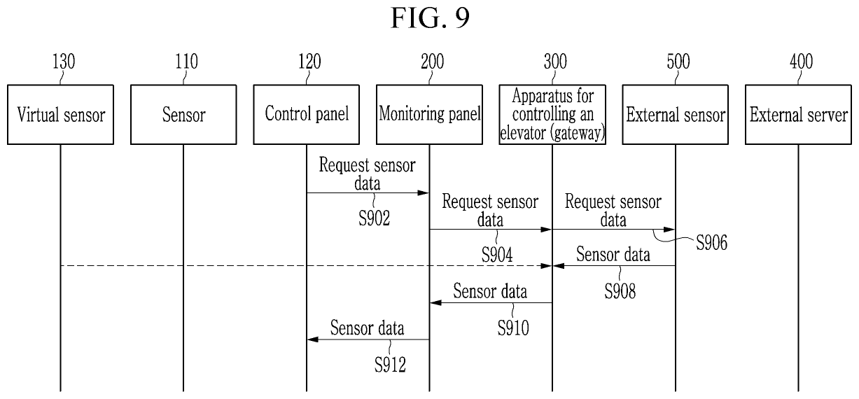

The process of interworking with the external sensor 500 in the elevator 100 may be started at the request of the external server 400 as shown in FIG. 7, and may be started by the control panel 120 or the monitoring panel 200 as shown in FIGS. 8 and 9. When an application utilizing the external sensor 500 is configured, the process of interworking with the external sensor 500 may be started by the request of the external server 400. For example, there may be no earthquake sensor inside the elevator 100, but there may be an emergency operation application according to earthquake detection in the external application. When interworking with the emergency operation application according to earthquake detection required, interworking with an external earthquake sensor or a data server storing the data may be required. In this case, the external server 400 may request sensor data through interworking with the external sensor 500.

First, referring to FIG. 7, the external server 400 requests sensor data from the apparatus for controlling an elevator 300 performing functions of a gateway function (S702).

The apparatus for controlling an elevator 300 requests sensor data from the external sensor 500 (S704), and collects sensor data from the external sensor 500 and the virtual sensor 130 mapped to the external sensor 500 (S706). The apparatus for controlling an elevator 300 may perform data conversion based on the elevator resource table or process a request from the external server 400. As described above, the resources of the elevator are classified based on OID and RID, and the real sensor and the virtual sensor can be identified by the most significant bit of the RID. The external server 400 also classifies the elevator resources based on the OID and RID, and requests sensor data to the apparatus for controlling the elevator 300 including the OID and RID of the desired external sensor 500, the apparatus for controlling the elevator 300 may request sensor data from the external sensor 500 requested by the external server 400 with reference to the elevator resource table.

The apparatus for controlling an elevator 300 may request elevator information interworked with the external sensor 500 to the monitoring panel 200 (S708), and may receive elevator information from the monitoring panel 200 (S714). If necessary, the monitoring panel 200 may request elevator information from the control panel 120 (S710) and collect elevator information from the control panel 120 (S712).

The apparatus for controlling the elevator 300 combines the received elevator information and sensor data, and transmits the combined data to the external server 400 (S716). Alternatively, if necessary elevator information has already been collected by the apparatus for controlling an elevator 300, the elevator information and sensor data may be combined and transmitted to the external server 400 without performing steps S708 to S714 (S716).

Meanwhile, referring to FIG. 8, when the monitoring panel 200 requests sensor data from the apparatus for controlling an elevator 300 (S802), the external server 400 requests sensor data from the external sensor 500 (S804), and collects sensor data from the external sensor 500 (S806).

Next, the apparatus for controlling the elevator 300 transmits the collected sensor data to the monitoring panel 200 (S808).

Also, referring to FIG. 9, it is possible to request sensor data from the control panel 120 to the monitoring panel 200 (S902).

When the monitoring panel 200 receives a sensor data request from the control panel 120, the monitoring panel 200 requests sensor data from the apparatus for controlling an elevator 300 performing a gateway function (S904). The monitoring panel 200 may acquire sensor data from the apparatus for controlling the elevator 300 through the same process as the process S804 to S808 described with reference to FIG. 8 (S906 to S910).

When the monitoring panel 200 acquires sensor data, it transmits the sensor data to the control panel 120 (S912).

The process shown in FIGS. 8 and 9 corresponds to a case of requesting external sensor data from the inside of the elevator 100. In this case, as described above, the corresponding request may be performed by the control panel 120 or the monitoring panel 200. When the apparatus for controlling an elevator 300 receives a request from the control panel 120 or the monitoring panel 200, the apparatus for controlling the elevator 300 requests information from the external sensor 500, and processes the information received from the external sensor 500 according to the message structure of the elevator 100, and then transmits the processed data to the control panel 120 or the monitoring panel 200.

Since the RID corresponding to the virtual sensor under the extension group allocated to the elevator 100 is not a device that exists in the elevator, when the monitoring panel 200 or the control panel 120 requests related data, the apparatus for controlling the elevator 300 receives a related message from an external device mapped as the virtual sensor and returns to the monitoring panel 200 or the control panel 120.

In addition, when an external device mapped as the virtual sensor is additionally installed in the elevator 100, the apparatus for controlling an elevator 300 uses the OID and RID as it is, and no longer manages the RID of the virtual sensor defined under the extension group as a virtual resource.

As described above, in an elevator environment that interworks elevator external data, it is necessary to strengthen security for external users to control the elevator. In the conventional case, devices connected from the outside of the elevator are limited to use only the read function due to security and safety issues, but when a network environment for interworking with the elevator 100 and external data is configured, there are cases in which network-based external control authority are required for elevator management and controlling, and it is essential to solve the security problem in order to allow external control authority. In addition, when the external control authority is allowed, a problem arises in which the control priorities between the internal device and external device are confused.

The apparatus for controlling the elevator 300 according to an embodiment divides external devices accessed from the outside into read-only devices and read-write devices having read and write authority. Furthermore, in the case of a device with write authority, the apparatus for controlling the elevator 300 maintains security for external control of the elevator 100 by allocating temporary authority to perform a specific command rather than a permanent authority assignment.

A device having write authority may be a device registered with write authority setting by an administrator, and the device having write authority may be an administrator terminal or a device to which write authority is set. The write authority device list is managed by the apparatus for controlling the elevator 300 that performs functions of a gateway.

The apparatus for controlling the elevator 300 stores the write authority device list including information on devices having write authorities in a hardware or software-based protection area (e.g., a SGX area, etc.), and manages the write authority device list.

In addition, in the elevator environment in which external data is interworked, devices capable of instructing control commands to the elevator 100 may be varied, such as the control panels 120 and 120a, the monitoring panels 200 and 200a, and the external server 400. The apparatus for controlling the elevator 300 allocates priorities to devices capable of instructing control commands to the elevator 100 and processes the control messages for control commands received from the devices according to the priorities.

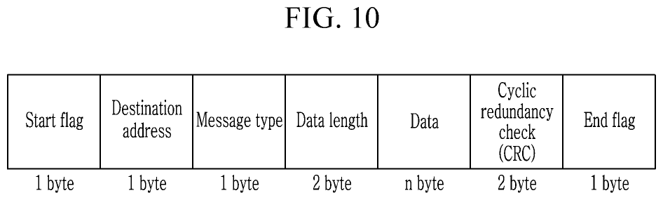

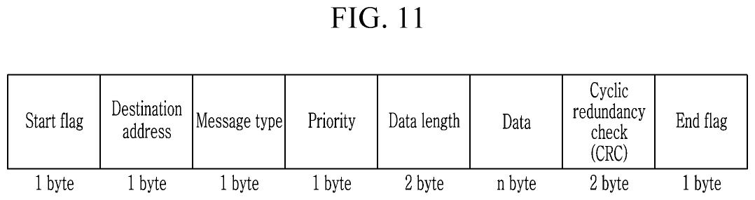

FIGS. 10 and 11 are diagrams illustrating an example of a control message structure according to an embodiment, respectively.

Referring to FIG. 10, a control message for a control command may have the same configuration as a message used between the control panel 120 and the elevator control device 300.

Also, as shown in FIG. 11, the control message may further include a priority field for setting priority.

As shown in FIG. 10, when the priority field in the control message is not defined and the message types are a data update request message and a data update response message, the data field may include a priority field.

The priority field has a size of 8 bits, the upper 2 bits among the 8 bits are defined as a reserved field, and the lower 6 bits among the 8 bits may be used for priority setting. It is possible to set the priority in the control panel 120, the monitoring panel 200, the apparatus for controlling the elevator 300 that performs functions of a gateway and the external server 400. Among the lower 6 bits, 1 bit is allocated for the priority of the control panel 120, 1 bit is allocated for the priority of the monitoring panel 200, 1 bit is allocated for the priority of the gateway, the other 2 bits are allocated for the priority of the external server 400, and 1 bit indicates a general situation, and is referred to as a normal bit. The normal bit is enabled in the general situation. In addition, when priority setting is required in the control panel 120, the monitoring panel 200, the gateway, and the external server 400, each device activates the bit allocated to the corresponding device. Activation may mean setting a corresponding bit to 1. For example, when priority setting is required for a control message transmitted from the monitoring panel 200, the monitoring panel 200 may set “00010000” in the priority field in the control message.

Applications of the external server 400 may be classified according to categories, and 2 bits allocated to the priority of the external server 400 may indicate the category of applications. For example, when an application applied to an elevator is classified into a general application and an emergency control-related application, 1 bit of the 2 bits allocated to the priority of the external server 400 may be allocated to the priority of the general application, and the other 1 bit of the 2 bits may be allocated to the priority of the emergency control-related application. In this case, a bit value of 10 may indicate the priority setting of the general application, and a bit value of 01 may indicate the priority setting of the emergency control-related application, and in this case, the normal bit value is set to 0.

The apparatus for controlling the elevator 300 determines priorities for devices capable of instructing control commands to the elevator 100. Since the control panel 120 is a device for directly controlling the elevator 100, it is determined with the highest priority, and the priorities can be allocated in the order of the monitoring panel 200, the gateway, that is, the apparatus for controlling the elevator 300 and the external device. Accordingly, when receiving control messages for the same command from the control panel 120, the monitoring panel 200, the apparatus for controlling the elevator 300, and an external device, the apparatus for controlling the elevator 300 transmits control message of the control panel 120 to the elevator so that the elevator processes the command of the control panel 120, and discards the control messages received from the remaining elevator control apparatus 300 and external devices.

In addition, commands that collide with each other can be simultaneously received from the control panel 120, the monitoring panel 200, the apparatus for controlling the elevator 300, and an external device. At this time, the apparatus for controlling the elevator 300 can process the messages according to the priorities. For example, a “3rd floor upward request” through the control panel 120 may be received simultaneously with a “3rd floor upward request” from the control panel 120. In this case, the messages are processed according to the values of the priority field, and when the corresponding priority bit in the message is activated in both the control panel 120 and the external device, the apparatus for controlling the elevator 300 processes the message of the control panel 120 so that the elevator can process the command of the control panel 120, and discards the message of the external device. The message processing order for the same priority bit may be set in the order of the control panel 120, the monitoring panel 200, and the external device through the gateway, or may be set in a different order.

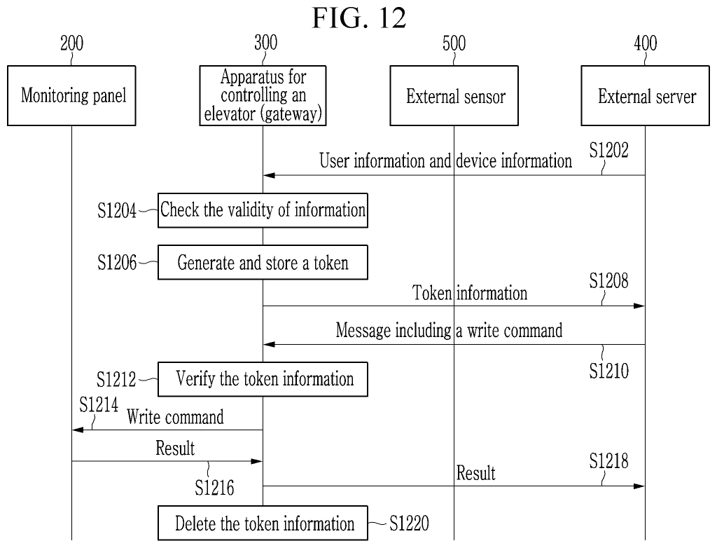

FIG. 12 is a diagram illustrating a security method of an apparatus for controlling the elevator according to an embodiment.

Referring to FIG. 12, in order for a device having a write authority to activate a write function, the device acquires an authorized token, and may activate a write function based on the token. In this case, a usage time and number of uses of the token used may be limited.

In order for the external server 400 in the write authority device list to acquire write authority, external server 400 transmits user information and device information to the apparatus for controlling the elevator 300 (S1202).

The apparatus for controlling the elevator 300 checks the validity of user information and device information (S1204). The apparatus for controlling the elevator 300 checks whether device information exists in the write authority device list.

When the user information and the device information are valid, the apparatus for controlling the elevator 300 generates a token and stores the token information in a hardware or software-based protection area (S1206). The apparatus for controlling the elevator 300 may store token information in an external security server.

The apparatus for controlling the elevator 300 transmits the generated token information in the external server 400 (S1208).

The external server 400 transmits a message including a write command together with the token information to the apparatus for controlling the elevator 300 (S1210). The external server 400 may set the priority through the priority field in the message.

The apparatus for controlling the elevator 300 verifies the token information (S1212), and when the token information verification is successful, transmits a write command to the monitoring panel 200 (S614), receives the result from the monitoring panel 200 (S1216), and transmits the result to an external server 400 (S1218). When the write command from the external server 400 is completed, the apparatus for controlling the elevator 300 deletes the token information (S1220).

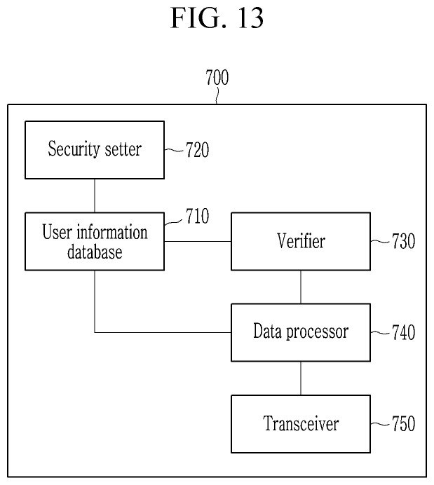

FIG. 13 is a diagram illustrating an apparatus for controlling the elevator according to an embodiment.

Referring to FIG. 13, the apparatus for controlling the elevator 700 includes a user information database 710, a security setter 720, a verifier 730, a data processor 740, and a transceiver 750.

The user information database 710 includes a write authority device list registered through an administrator terminal or an administrator account. In addition, the user information database 710 stores user information having access to the elevator 100. The user information may include user login information such as an ID and password, designated terminal information such as a terminal serial number and MAC address, and authority level information of the user.

The security setter 720 manages read and write authorities for external devices, and provides temporary authority for performing a specific command to a device having write authority. A token method can be used to provide temporary authority. The security setter 720 generates a token for a device whose validity is verified and manages token information.

Also, the security setter 720 may set a priority for a device capable of instructing a control command to the elevator 100.

The verifier 730 verifies the validity of the device information having the write authority and the user information.

When a message including a write command is received together with token information, the data processor 740 verifies the received token information, and when the token information is successfully verified, processes the write command included in the message. In addition, the data processor 740 processes the message according to the priority of the device and the value of the priority field in the message. For example, as described above, when control messages for the same command are received from two or more devices among the control panel 120, the monitoring panel 200, the apparatus for controlling the elevator 300, and the external device, the data processor 740 is the messages according to the priority of the devices and the values of the priority field in the messages

The transceiver 750 transmits and receives messages between the external device of the elevator 100 and the monitoring panel 200 of the elevator 100. The transceiver 750 may support a physical layer supporting serial communication used in the elevator 100 in order to interwork with the elevator 100. The transceiver 750 may support CAN communication. In addition, the transceiver 750 may support a physical layer for IoT communication between the external server 400 or the external sensor 500.

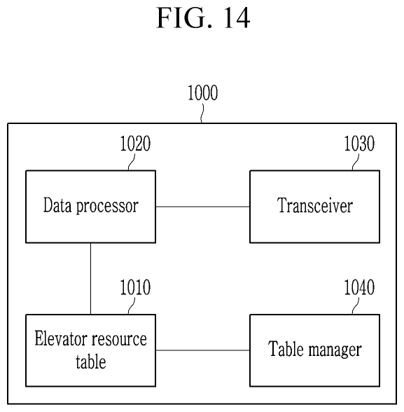

FIG. 14 is a diagram illustrating an apparatus for controlling the elevator according to another embodiment.

Referring to FIG. 14, the apparatus for controlling the elevator 1000 may include an elevator resource table 1010, a data processor 1020, a transceiver 1030, and a table manager 1040.

The elevator resource table 1010 stores OIDs and RIDs. In this case, the virtual sensor and the real sensor may be identified by the RID under the OID corresponding to the extension group. Alternatively, a virtual sensor and a real sensor may be identified by RIDs under all OIDs.

The data processor 1020 performs data conversion between the control panel 120 or the monitoring panel 200 of the elevator 100 and the external server 400 and between the control panel 120 or the monitoring panel 200 of the elevator 100 and the external sensor 500. The external server 400 or the elevator 100 utilizing the elevator resource table 1010 performs a request based on RID, and the data processor 1020 requests actual data from an external device corresponding to the RID and returns a response value or the stored data value.

The transceiver 1030 communicates with the control panel 120 of the elevator 100, the monitoring panel 200 of the elevator 100, the external server 400, and the external sensor 500. The transceiver 1030 may support a physical layer supporting serial communication used in the elevator 100 in order to interwork with the control panel 120. The transceiver 1030 may support CAN communication. In addition, the transceiver 1030 may support a physical layer for IoT communication between the external server 400 or the external sensor 500.

The table manager 1040 manages the elevator resource table 1010. The table manager 1040 manages the OIDs and RIDs in the elevator resource table 1010, and maps information such as information of an external device, URL information, and a reserved identifier address of an external device connected to the OID and RID to the OID and RID and manages them. The table manager 1040 virtualizes a device installed outside of the elevator 100 to generate a virtual sensor, allocates OID and RID and a reserved identifier address for the virtual sensor, and stores information allocated to the elevator resource table 1010.

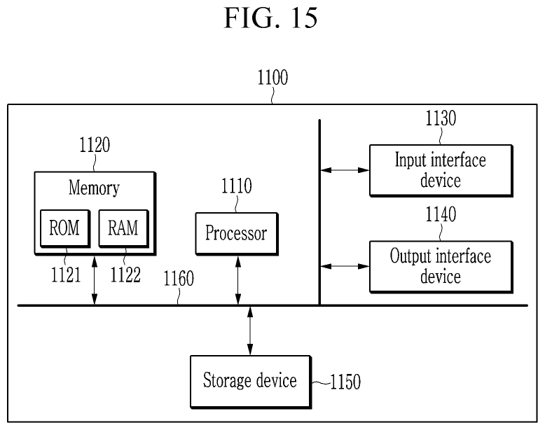

FIG. 15 is diagram illustrating an apparatus for controlling the elevator according to another embodiment.

Referring to FIG. 15, the apparatus for controlling the elevator 1100 may represent a computing device in which the method for interworking between elevator internal data and elevator external data for elevator control described above is implemented.

The apparatus for controlling the elevator 1100 may represent a computing device in which the security method in an elevator environment that interworks external data described above is implemented.

The apparatus for controlling the elevator 1100 may represent a computing device in which a method for interworking elevator internal data and elevator external data and a security method in an elevator environment linking external data are implemented.

The elevator control device 1100 may include at least one of a processor 1110, a memory 1120, an input interface device 1130, an output interface device 1140, and a storage device 1150. Each of the components may be connected by a common bus 1160 to communicate with each other. In addition, each of the components may be connected through an individual interface or an individual bus centered on the processor 1110 instead of the common bus 1160.

The processor 1110 may be implemented as various types such as an application processor (AP), a central processing unit (CPU), a graphics processing unit (GPU), etc., and may be any semiconductor device that executes a command stored in the memory 1120 or the storage device 1150. The processor 1110 may execute a program command stored in at least one of the memory 1120 and the storage device 1150. The processor 1110 may be configured to implement the method of interworking between elevator internal data and elevator external data, and may be configured to implement the security method in an elevator environment that interworks external data.

The memory 1120 and the storage device 1150 may include various types of volatile or non-volatile storage media. For example, the memory 1120 may include a read-only memory (ROM) 1121 and a random access memory (RAM) 1122. In an embodiment, the memory 1120 may be located inside or outside the processor 1110, and the memory 1120 may be connected to the processor 1110 through various known means.

The input interface device 1130 is configured to provide data to the processor 1110.

The output interface device 1140 is configured to output data from the processor 1110.

In addition, at least some of the method for interworking the elevator internal data and the elevator external data for elevator control, and at least some of the security method in an elevator environment that interworks external data according to an embodiment may be implemented as a program or software executed in a computing device, and the program or software is stored in a computer-readable medium.

In addition, at least some of the method for interworking the elevator internal data and the elevator external data for elevator control, and at least some of the security method in an elevator environment that interworks external data according to an embodiment, may be implemented as hardware capable of being electrically connected to a computing device.

According to an embodiment, it is possible to efficiently interwork with external data such as public data that is already provided or devices such as sensors installed for common use outside, and through this, the elevator can be controlled more efficiently, and it can detect and respond to emergencies without installing devices such as sensors inside the elevator.

Also, when an external sensor is installed to inside the elevator, it can be applied by simply changing the elevator resource table. In addition, security can be strengthened by using a token method in allocating write authority to an external device or external server, and a problem of confusion or collision of control commands can be solved by setting priorities for control authorities of devices.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A method for controlling an elevator by interworking with external devices in an apparatus for controlling an elevator, the method comprising:
generating token information for an external device to which a write command is to be performed and transmitting the token information to the external device;
receiving a control message including a write command together with the token information from the external device;
verifying the token information; and
processing the control message when the token information is verified.

2. The method of claim 1, further comprising:
receiving a result of the write command from the elevator and transmitting the result to the external device; and
deleting the token information.

3. The method of claim 1, wherein the transmitting of the token information includes checking the write authority of the external device based on the information of the external device.

4. The method of claim 1, further comprising storing and managing information on devices for which write authority is set by an administrator.

5. The method of claim 1, further comprising allocating priorities of devices capable of instructing a control command to the elevator.

6. The method of claim 5, wherein the devices includes a control panel, a monitoring panel, and the external device, and
the allocating of priorities includes allocating priorities in the order of the control panel, the monitoring panel, and the external device.

7. The method of claim 5, wherein the control message includes a priority field, and
each bit in the priority field is allocated for the priority setting of the devices, and the devices set the priority by activating the allocated bit.

8. The method of claim 7, wherein the processing of the control message includes processing received messages based on the priorities of the devices and values of bits in the priority field when control messages including the same or conflicting control command are received from two or more devices.

9. An apparatus for controlling an elevator that controls the elevator by interworking with an external device through a network, the apparatus comprising
a user information database that stores a write authority device list including information on devices with write authority and user information of devices having an access authority of the elevator and
a security setter that manages the access authority of the external device, provides a temporary authority for performing a control command to the device with the write authority, and sets the priorities of the devices having the access authority.

10. The apparatus of claim 9, wherein the security setter provides token information to an external device that wants to perform a write command, and deletes the token information when the write command is completed.

11. The apparatus of claim 10, wherein the security setter, before providing the token information, checks the write authority of the external device based on the information of the external device that wants to perform the write command.

12. The apparatus of claim 9, wherein the security setter allocates priorities in the order of a control panel, a monitoring panel, and the external device.

13. The apparatus of claim 9, wherein the control command includes a priority field, and
each bit in the priority field is allocated for the priority setting of each device, and the each device sets the priority by activating the allocated bit.

14. The apparatus of claim 13, further comprising a data processor processes received control commands based on the priorities of the devices and values of bits in the priority field when receiving the same or conflicting control commands from two or more devices.

15. The apparatus of claim 9, wherein the security setter basically provides read authorities to the devices having the access authority, and registers the information of the device for which the write authority is set by an administrator to the write authority device list.

16. A method for controlling an elevator by interworking with a control panel or a monitoring panel of the elevator in an apparatus for controlling elevator, the method comprising:
supporting interworking with external devices installed outside the elevator;
processing external data from the external device and internal data of the elevator using an elevator resource table; and
monitoring the elevator using the external data and the internal data,
wherein, when resources of the elevator are divided into a plurality of groups, the elevator resource table includes a group identifier for identifying each group and a resource identifier for identifying individual devices located in each group.

17. The method of claim 16, wherein the processing includes:
mapping the external device to a virtual sensor; and
managing the resource identifier of the virtual sensor as another group among the plurality of groups.

18. The method of claim 17, wherein the managing includes allocating the resource identifier of the virtual sensor by utilizing the most significant bit value of the resource identifier of the external device.

19. The method of claim 17, wherein the processing further includes:
receiving an external data request from inside the elevator; and
collecting the external data through interworking with the external device according to the external data request,
wherein the external data request includes the resource identifier of the device to be requested.

20. The method of claim 17, wherein the processing further includes:
receiving a data request from outside the elevator; and
when the device corresponding to the data request is not installed in the elevator, collecting data corresponding to the data request through interworking with the external device and transmitting the data to the outside of the elevator,
wherein the data request includes a resource identifier of a device to be requested.
